(19) United States
(12) Patent Application Publication
(10) Pub. No.: US 2004/0125999 A1
(43) Pub. Date: Jul. 1, 2004

(54) Method for management of the dynamic range of a radiological image

(76) Inventors: Razvan Iordache, Paris (FR); Serge Muller, Guyancourt (FR); Fanny Jeunehomme, Versailles (FR); Jean Lienard, Igny (FR)

Correspondence Address: Jay L. Chaskin, Cantor Colburn LLP, 55 Griffin Road South, Bloomfield, CT, 06002, US

(21) Appl. No.: 10/721,613

(22) Filed: Nov. 25, 2003

(30) Foreign Application Priority Data
Nov. 27, 2002 (FR) 02 14917

(51) Int. Cl. G06K 9/00; G06K 9/40

(52) U.S. Cl. 382/132; 382/263

(57) ABSTRACT

A method for management of dynamic range of a radiological image by processing an acquired image by subjecting context components as well as components of the details of the image to contrast expansion factors whose value depends on a signal of the context image, at the position of the concerned pixels. A signal in terms of gray levels or in terms of acquired doses is converted into a radiological thicknesses signal carry out the processing. At the end of the processing, the dynamic range of the processed image is reset so that it corresponds to that of a radiology apparatus, especially by compression. If desired, the factors are modified as a function of a choice made by the user.

### CROSS-REFERENCE TO RELATED APPLICATIONS

This application claims the benefit of a priority under 35 USC 119(a)-(d) to French Patent Application No. 02 14917 filed Nov. 27, 2002, the entire contents of which are hereby incorporated by reference.

### BACKGROUND OF THE INVENTION

The present invention and embodiments thereof is a method for the management of the dynamic range of an image that can be used in the field of medical radiology and, in this field, especially in mammography.

An image, preferably a digital image, to be displayed is an image of the radiological thicknesses of the object crossed by a source of radiation, e.g., X-rays, which has a wide dynamic range, typically equal to 12 bits. The object typically can be an organ or anatomical feature. Radiological thickness is the thickness of an object as measured by the radiation, namely the thickness measured in taking account of the absorption of the materials crossed. For example, 0.1 cm of bone has the same radiological thickness as 1 cm of water. The monitors on which the images are displayed have a much smaller dynamic range, typically equal to 8 bits. The monitors make it possible to differentiate only 256 gray levels. In the prior art, the dynamic range of the digital image for gray levels located at both ends of the dynamic range is compressed. This results in a lack of clarity for the parts of the image corresponding to the compressed dynamic part.

EP-A-1 113 392 presents a method to compensate for the variations in thickness before the compression of the dynamic range, especially at the boundary between the high-density regions and the low-density regions of the X-rayed organ. The effect obtained is the reduction of the dynamic range of the signal. As a consequence, the entire organ can be displayed without saturation.

The visibility of the radiological structures may be increased if the reduction of the dynamic range of the image is combined with a contrast-expansion or contrast-heightening step. WO 01/69532, presents a method to compress the dynamic range of the image based on the contrast, in which the low frequencies and the contrast are adjusted separately to adjust the dynamic range of the display device. The reduction of the dynamic range and the expansion of contrast are separated, but both include the compression of the dynamic range (between the original dynamic range and the dynamic range of the imaging device), thus leading to a very major limitation: the user has access only to an eight-bit representation of the image that is encoded on 12 bits.

### BRIEF DESCRIPTION OF THE INVENTION

The invention and embodiments thereof is a method for management of the dynamic range of a radiological image comprising: acquiring an image of an object with a radiology apparatus having a radiation detector and a source of radiation, the image thus acquired possessing a wide dynamic range of acquisition; computing a radiological thicknesses of the image of the object crossed by the radiation; filtering the image of the radiological thicknesses to obtain a context image; subtracting the context image from the image of the radiological thicknesses to obtain an image of the details; processing the context image by means of a first table computed from the image of the radiological thicknesses to obtain an image with a reduced dynamic range; processing the context image by means of a second table computed from the image of the radiological thicknesses to obtain an image of coefficients which will then weight the image of the details to obtain an image of enhanced details; and adding together the image with reduced dynamic range and the image of the enhanced details to obtain an image with reduced dynamic range and heightened contrast in which the differences between the object structures are preserved and the dynamic range of the image with reduced dynamic range and heightened contrast is compressed so that it is contained within the dynamic range of an imaging device with a small dynamic range, this small dynamic range being smaller than the wide dynamic range.

### BRIEF DESCRIPTION OF THE DRAWINGS

The invention and embodiments thereof will be understood more clearly from the following description and from the appended figures. These figures are given purely by way of an indication and in no way restrict the scope of the invention. Of these figures:

FIG. 1 is a diagrammatic view of the management of the dynamic range and of its processing; and

FIG. 2 is a view of the processing steps of the method.

### DETAILED DESCRIPTION OF THE INVENTION:

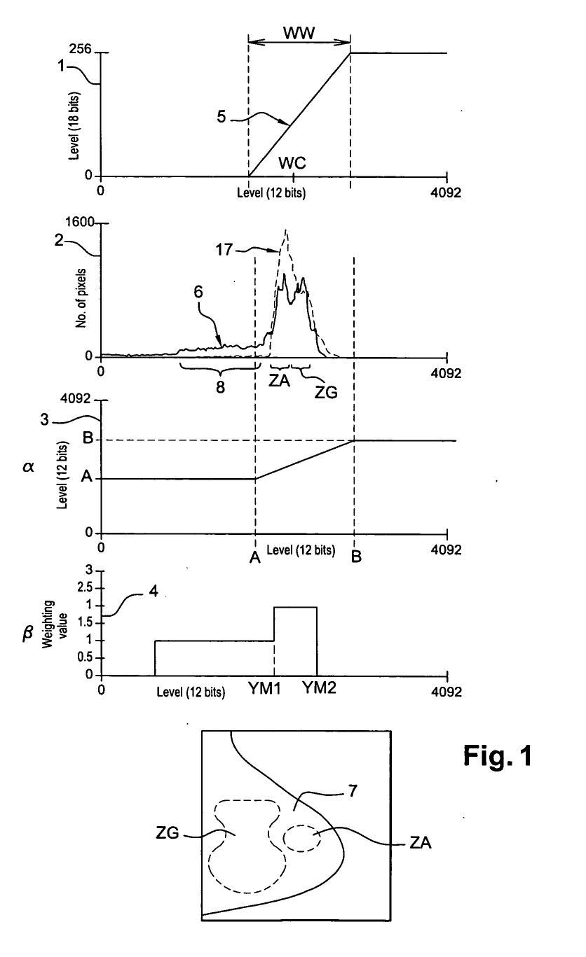

FIG. 1 shows four graphs, 1, 2, 3 and 4 to explain the processing. In these graphs, the X-axis represents a measurement of the radiological signal in terms of radiological thickness. The signal has a wide dynamic range, typically encoded on 12 bits. The passage from the acquired image to the image of the radiological thicknesses necessitates a logarithmic conversion, but the correspondence between them is in any case monotonic. FIG. 1 also gives a schematic view, beneath the four graphs, of a radiological image of a breast. In the four graphs, the first graph shows a correspondence 5 between the signal of radiological thickness represented on a wide dynamic range, for example 2¹², and a signal in terms of gray levels that can be displayed on a real display unit, with gray levels ranging from 0 to 255, corresponding to 8 bits, with a smaller dynamic range.

In a known way, the first graph 1 comprises a dynamic window WW (which controls the maximum differential gain (contrast)) locked by its center WC (the level of maximum differential gain) to a given position of the total dynamic range of the signal of radiological thickness. While the thickness signal is expressed on 12 bits, the useful signal used to control the imaging device can only be a signal expressed with 8 bits, namely 1 byte.

The graph 2 placed below this first graph 1 is a real histogram 6, in an unbroken line, of the breast 7 in the field of the radiological thickness visible in the image presented beneath the four graphs. In a known way, this histogram 6 comprises a bordering part 8, representing the edge of the breast at its end and, typically, two peaks corresponding to an adipose zone ZA and a glandular zone ZG.

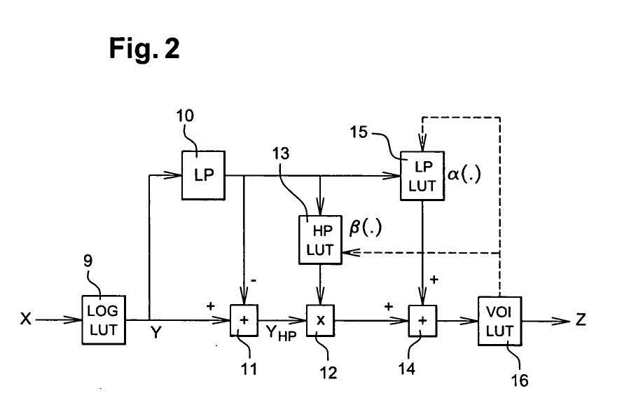

FIG. 2 shows the steps of the method for management of dynamic range. From an image acquired by a radiology apparatus (not shown), a signal referenced X in FIG. 2 is obtained. Images of components of context and components of the details are extracted from this signal X. Given a radiological phenomenon of acquisition of the I=I₀ₑₓₚ(−μx) type, it is known that μx can be expressed in the form μx=Log(I₀)−Log(I), I being the signal really measured by an electronic radiological detector, or possibly read from a digitized X-ray image. For a thickness x that is constant (because the breast is compressed in the same way throughout), this method gives an image of the radiological density μ at each point, at each pixel of the image. To this end the signal X will be converted by a circuit 9 into a radiological thickness signal, referenced Y in FIG. 2. While the signal X traditionally has a dynamic range of 14 bits and is expressed in doses, the logarithmic conversion 9 gives a radiological thickness signal Y on 12 bits per pixel. The conversion 9 is preferably made by a reading of a pre-computed table, LUT. It is this thickness signal Y that is represented on the x axes of the four graphs 1 to 4 of FIG. 1.

The signal Y is then transmitted to a spatial filter 10 producing an output signal Y_{LP}. The filter 10 is a median-type low-pass spatial filter, with a large core, for example a 2-cm. core used in digital mammography. However, it could be a statistical filter of another type to give similar or possibly better results. The signal Y_{LP} as well as the signal Y is given on 12 bits. They are subtracted, one from the other, in the subtractor 11 and give rise to a signal Y_{HP} representing the details of the image. From the low-pass filtering by the filter 10, the image signal Y is converted into a context signal Y_{LP}. When the context signal is subtracted from the starting signal all that remains of course is the signal of the details.

The detail signal Y_{HP} is then multiplied, pixel by pixel, in a multiplier 12 by coefficients given by a table 13. Table 13 proposes coefficients that, pixel by pixel, have a value that depends on their environment. This dependence may be obtained here as follows: the signal of the context image that corresponds to a processed pixel may be used as the read address of the table 13 from which the coefficient is extracted. The table 13 thus comprises a correspondence between gray levels of the context signal and weighting coefficients to be applied to the signal of the details that, besides, is introduced into the multiplier 12.

This conversion that heightens contrast was not present in the teaching of EP-A-1 113 392. The signal produced by the multiplier 12 is added in an adder 14 to the context signal. Preferably, this context signal itself undergoes a conversion by a correction filter 15. The correction filter 15, like the correction filter 13, is made in the form of a table of correspondence also known as a look-up table LUT. The characteristic of this table, once again, is to produce a modification. In this case, it is a modification of the context signal. This modification a(x) is itself a function of the value x of this context signal. The signal available at the output of the adder 14 has all the desired improvements (which shall be explained further below) However, because of its 12-bit dynamic range, it does not correspond to the dynamic range of the display unit on 8 bits. To this end, a conversion circuit 16 placed downstream, in particular a correspondence table LUT, makes it possible to have one 8-bit signal Z per pixel at output. In practice, the circuit 16 can make a conversion of the type shown in the graph 1 of FIG. 1.

Circuit 15 performs a conversion of the type entailing multiplication by α(Y_{LP}) type. The value of a is shown in the graph 3 of FIG. 1. This conversion furthermore corresponds to the conversion taught in the EP-A-1 113 392. Its object is to compress the dynamic range of the image acquired so that it corresponds to an expected width. In particular, for the regions located at the edge of the breast, α(x) will be greater than x. At the other end of the scale, for the highest signal values acquired, α(x) will be smaller than x. The coefficient is decreasing so as to bring the dynamic range of the acquired image, in all, to a dynamic range of A to B.

In circuit 13, the modification β is related to the environment, graph 4. In a first example, there is deemed to -be correspondence between the adipose zones ZA and the glandular zones ZG on the one hand, and the gray levels or equivalence thicknesses of the histogram 6 on the other hand. In the adipose zones ZA and glandular zones ZG, it is thus determined that a radiological thickness is included in a section YM1 and YM2 of the dynamic range. It is then decided, for example, that at the passage of the value YM1, the coefficient β contributed by the circuit 13 will be increasing, for example, between 1 and a higher threshold, for example 2 or 3. A coefficient β at 1 keeps the details as they are. When the details are enhanced, β equals 2 or 3, for example, for the zones ZG and ZA.

The histogram 17 of the image with reduced dynamic range and heightened contrast is shown in dashes in the graph 2.

The coefficients α and β may thus be assigned to each of the pixels of the image and, in themselves, form modification images. The values of these coefficients are a function, specific for each image, of the values of the signals Y_{LP} of the context image at their position.

The assigning of a given value to a coefficient β, as a function of the environment, can then be done in two ways. In the first way, the place of the zones ZA and ZG in the image is identified, and, for the pixels whose geographical coordinates correspond to these places, the coefficient β is modulated correspondingly. In this case, the table LUT 13 (or 15 for α) is addressed by the coordinates of the pixel concerned in the image. In the second way, preferably, the correspondence referred to here above is used, and the table of coefficients 13 (the same would apply for the table of coefficients 15) is addressed by the gray level, or the radiological thickness of the signal concerned. In other words, a signal with a given equivalent thickness, typically greater than the threshold YM1, is considered to be a signal of the zone ZA or ZG and then the maximum contrast expansion, for example a coefficient β of 2 or 3, is applied to it.

As compared with the prior art, it can be seen that there is a great difference because these techniques included the designation of a spatial window in the displayed image, this window being circumscribed by means of a mouse or trackball in the very image of the breast. The image of the designated window was then analyzed and its contrast optimized as a function of the variation of the signal in this designated window.

In a second example, the environment is taken into account by estimating the proportion of an anatomical structure or feature, such as fibro-glandular tissue, at the position of each pixel. This estimation is described by J. Kauffiold, J. A. Thomas, J. W. Eberhard, C. E. Galbo, and D. E. Gonzalez Trotter, “A Calibration Approach to Glandular Tissue Composition Estimation in Digital Mammography,” in Med. Phys. 29 (8), pp. 1867-1880, August 2002. According to this teaching, there are known ways of estimating a proportion of fibro-glandular tissue in each pixel. This proportion can then be used to condition the values of the coefficients, if necessary after low-past spatial filtering. For example β becomes constantly greater as and when this proportion rises. In this case, the computation of the two functions used to modify the images of context and the images of the details are predefined as functions of proportion of fibro-glandular tissue, and are adapted, by a calibration procedure, to each radiological thickness image.

To the same extent as the coefficient a is linear in pieces, the coefficient β in this second example will be constant in pieces. The coefficient a is positive and non-decreasing so as to preserve the relationship of order between the thicknesses of the different tissues. As for the coefficient β it is a positive function that can take values lower than, equal to or greater than 1 depending on whether the details have to be overlooked, kept as such, or, on the contrary, presented with greater contrast. Preferably a will have a sharp slope so as to compensate for the effects of the variation of thickness due to the non-compression of the edges of the breast.

The threshold YM1, or any other threshold, is determined by considering the histogram 6, especially so as to segment the adipose and fibro-glandular regions. For β, the choice of a function that is constant by pieces may permit the use of different coefficients of expansion for the adipose and fiber-glandular zones respectively.

While the graph 1 of FIG. 1 shows a display window in terms of basic dynamic range, it may happen that the practitioner wishes to modify the position and/or the width of the display window, WC and WW respectively. This modification can occur in circuit 16, and a signal γ is produced for the modification of the coefficients α and β. When the width of display is modified from an initial value WW to a final value WW′, the coefficients α and β will be modified according to a modification of the type α/α′=Ψ (WW/WW′) and β/β′=ρ (WW/WW′). These are formulae in which Ψ and ρ are non-decreasing functions. The terms with the sign ' relate to a modified form of the basic term. The basic terms α, β and WW result from an initial setting of the processing and display system of the radiology apparatus. Any newly presented image is presented with these basic values. The practitioner then performs modifications pertaining to these basic terms. The functions Ψ and ρ are determined empirically.

By acting in this way, it is thus possible to take account of the particular wishes of the practitioner. This mechanism can be implemented in two ways. In a first implementation, the total processing is resumed whenever the user changes the constraints of contrast, the requirement being that the overall appearance of the object, for example, a breast, must remain the same. In a second mode of implementation, the low-frequency image is processed for once and for all. In practice, the image Y_{LP} is thus prepared for once and for all, and it is stored in the memory. When the user changes the contrast of display, a new processed image can be obtained without having to filter the acquired image again. The second approach is less demanding in terms of computation time but introduces a significant complication in the processing of the memory.

For the user, it provides a single image of the breast, in which the contrast in the adipose tissues is similar to the contrast obtained by setting the dynamic range of display, WW, for the optimum display of the adipose tissues, and the contrast of the glandular tissues is similar to the contrast obtained by setting the dynamic range of display, WW, for an optimum display of the fibro-glandular tissues.

Secondly, it is possible to modify the contrast of the image in a usual way, namely by a modification of the correspondence table 16. All the tissues remain visible and wherein the contrast of the local structures is maximized for the displayed range. In the absence of this modification, the number of visible tissues would be greatly reduced when the chosen contrast is high. It is therefore possible to obtain images with a far better contrast than that obtained by films or screen systems and, at the same time, preserve the visibility of all the tissues (pectoral, glandular, adipose, subcutaneous, skin etc). This approach leads to an improved detectability of breast cancers as well as a reduction of the constraints of ambient light needed to display the image. This means that if the conditions of display are not the best conditions, additional processing operations will nevertheless enable satisfactory observation of the images.

Since the processing is based on quantitative and therefore objective information, it offers optimum display independent of the configuration of acquisition and independent of the radiology machine used for this purpose.

Because the processing relates to the display contrast, the overall impression of the breast is always the same and makes the operation very natural for the radiologist. In the absence of this processing, it is unlikely to find a formulation of expansion that satisfies all the demands. An image processed with great expansion would appear to be artificial when displayed with a standard contrast. An image processed with a low contrast expansion would not be capable of showing all the tissues with high contrast.

The present invention and embodiments thereof facilitate the reading of mammography images obtained by using a digital imaging technology—with a solid state detector and digital acquisition system—by which a practitioner, at one glance and possibly without having to adjust the display in any way whatsoever, can access an image that is clear and well contrasted at all points. In such an image, the radiologist is thus able to identify substantially all the clinical signs by perceiving the relationships between the different components of the image.

To keep the possibility of displaying several eight-bit representations of this digital image encoded on 12 bits, the present invention and embodiments thereof separate the three processing steps: (i) the reduction of the dynamic range, (ii) the expansion of contrast and (iii) the compression of the dynamic range. The image of the radiological thicknesses undergoes the first two processing operations to compensate for variations in thickness and heighten the contrast. Then, the displayed image is obtained by carrying out a conversion from, for example, 12 bits to 8 bits. The user can modify the conversion to make an overall change in the contrast and redefine the zone of the thicknesses displayed. Furthermore, in a real-time scenario, the compensation for the variations in thickness and the heightening of the contrast can be adapted to the user's parametrization in order to optimize the display.

In the present invention and embodiments thereof, context components and detail components are produced from the image of the radiological thicknesses. When the image is taken, with the breast compressed between a breast-carrying tray and a compression pad, the thickness of the breast is imposed mechanically so as to be the same throughout. It is useful then to process the signal measured in terms of radiological thicknesses in taking account of the radiological density μ of the tissues examined. Furthermore, to take account of the imaging apparatus, the image whose contrast has been improved as a function of medical characteristics, is ultimately corrected so that it corresponds to the dynamic range of the display device used. The context images and the images of the details are modified so that their contrast depends on the local conditions of the context image at their position. In this way, it is possible to create a contrast expansion model simultaneously in different zones that, in principle, are exclusive with respect to each other, so that the practitioner, at a single glance, can access the totality of the information sought.

The criteria used to determine medical characteristics were empirical and validated by a clinical study. In this clinical study, a batch of images was processed by the dynamic range management method as disclosed and these images were presented to a range of specialists, and their unanimous approval was obtained on the quality of the images presented. Another criterion was that of not creating false positives or false negatives. A false positive is an artificially converted image that also gives the false impression of the presence of a radiological accident to be detected. A false negative is an expansion of contrast that would lead to the disappearance of a radiological accident that is really present and masked after the processing operation.

Various modifications may be made or proposed by one skilled in the art to the function and/or way and/or result of the disclosed embodiments and equivalents thereof without departing from the scope of the invention.

What is claimed is:

1. A method for management of a dynamic range of a radiological image comprising:
acquiring an image of an object with a radiology apparatus having a detector and a source of radiation, the image thus acquired possessing a wide dynamic range of acquisition;
computing a radiological thicknesses of the image of the object crossed by the radiation;
filtering the image of the radiological thicknesses to obtain a context image;
subtracting the context image from the image of the radiological thicknesses to obtain an image of the details;
processing the context image by means of a first table computed from the image of the radiological thicknesses to obtain an image with a reduced dynamic range;
processing the context image by means of a second table computed from the image of the radiological thicknesses to obtain an image of coefficients which will then weight the image of the details to obtain an image of enhanced details; and
adding together the image with reduced dynamic range and the image of the enhanced details to obtain an image with reduced dynamic range and heightened contrast in which the differences between the anatomical structures are preserved, and the dynamic range of the image with reduced dynamic range and heightened contrast is compressed so that it is contained within the dynamic range of an imaging device with a small dynamic range, this small dynamic range being smaller than the wide dynamic range.

2. The method according to claim 1 wherein:
to obtain the image of the enhanced details, the image of the details is weighted, pixel by pixel, by an image of coefficients, the values of the coefficients being a positive function of the values of the context image at their position.

3. The method according claim 1 wherein:
the context image is built from the image of the radiological thicknesses by a median filtering, or by a statistical filtering of another type.

4. The method according claim 2 wherein:
the context image is built from the image of the radiological thicknesses by a median filtering, or by a statistical filtering of another type.

5. The method according to claim 1 wherein:
the function applied to each pixel of the context image to obtain the image with reduced dynamic range is positive, linear by pieces and non-decreasing and/or the coefficients which, in each pixel, multiply the detail image to obtain the image of the enhanced details are computed by applying a positive function, that is constant by pieces, to each pixel of the context image, the coefficients being smaller than 1 if the contrast at their position has to be reduced, equal to 1 if the contrast at their position has to be kept as it is and greater than 1 if the contrast at their position has to be heightened.

6. The method according to claim 2 wherein:
the function applied to each pixel of the context image to obtain the image with reduced dynamic range is positive, linear by pieces and non-decreasing and/or the coefficients which, in each pixel, multiply the detail image to obtain the image of the enhanced details are computed by applying a positive function, that is constant by pieces, to each pixel of the context image, the coefficients being smaller than 1 if the contrast at their position has to be reduced, equal to 1 if the contrast at their position has to be kept as it is and greater than 1 if the contrast at their position has to be heightened.

7. The method according to claim 3 wherein:
the function applied to each pixel of the context image to obtain the image with reduced dynamic range is positive, linear by pieces and non-decreasing and/or the coefficients which, in each pixel, multiply the detail image to obtain the image of the enhanced details are computed by applying a positive function, that is constant by pieces, to each pixel of the context image, the coefficients being smaller than 1 if the contrast at their position has to be reduced, equal to 1 if the contrast at their position has to be kept as it is and greater than 1 if the contrast at their position has to be heightened.

8. The method according to claim 1 wherein:
the compression of the dynamic range is obtained by a positive and non-decreasing function, characterized by two parameters adjustable by the user, the parameter, which controls the maximum differential gain, and the parameter that defines the maximum differential gain level in the starting dynamic range.

9. The method according to claim 2 wherein:
the compression of the dynamic range is obtained by a positive and non-decreasing function, characterized by two parameters adjustable by the user, the parameter that controls the maximum differential gain and the parameter which defines the maximum differential gain level in the starting dynamic range.

10. The method according to claim 3 wherein:
the compression of the dynamic range is obtained by a positive and non-decreasing function, characterized by two parameters adjustable by the user, the parameter that controls the maximum differential gain and the parameter which defines the maximum differential gain level in the starting dynamic range.

11. The method according to claim 4 wherein:
the compression of the dynamic range is obtained by a positive and non-decreasing function, characterized by two parameters adjustable by the user, the parameter that controls the maximum differential gain and the parameter which defines the maximum differential gain level in the starting dynamic range.

12. The method according to claim 8 wherein:
the operations of processing the images of context and the images of the details are modified as a function of the value that controls the maximum differential gain selected by the user.

13. The method according to claim 2 wherein:
the operations of processing the images of context and the images of the details are modified as a function of the value that controls the maximum differential gain selected by the user.

14. The method according to claim 3 wherein:
the operations of processing the images of context and the images of the details are modified as a function of the value that controls the maximum differential gain selected by the user.

15. The method according to claim 4 wherein:
the operations of processing the images of context and the images of the details are modified as a function of the value that controls the maximum differential gain selected by the user.

16. The method according to claim 1 wherein:
the computations of the two functions used to modify the images of context and of the details are predefined as functions of proportion of object structure, and are adapted by a calibration procedure to each radiological thickness image.

17. The method according to claim 2 wherein:
the computations of the two functions used to modify the images of context and of the details are predefined as functions of proportion of object structure, and are adapted by a calibration procedure to each radiological thickness image.

18. The method according to claim 3 wherein:
the computations of the two functions used to modify the images of context and of the details are predefined as functions of proportion of object structure, and are adapted by a calibration procedure to each radiological thickness image.

19. The method according to claim 4 wherein:
the computations of the two functions used to modify the images of context and of the details are predefined as functions of proportion of object structure, and are adapted by a calibration procedure to each radiological thickness image.

20. The method according to claim 8 wherein:
the computations of the two functions used to modify the images of context and of the details are predefined as functions of proportion of object structure, and are adapted by a calibration procedure to each radiological thickness image.

21. The method according to claim 12 wherein:
the computations of the two functions used to modify the images of context and of the details are predefined as functions of proportion of object structure, and are adapted by a calibration procedure to each radiological thickness image.
